(19) United States
(12) Patent Application Publication
(10) Pub. No.: US 2026/0046186 A1
(43) Pub. Date: Feb. 12, 2026

(54) Time Division Duplexing Pattern Adaptation in a Communication Networks

(71) Applicant: Telefonaktiebolaget LM Ericsson (publ), Stockholm (SE)

(72) Inventors: Junaid Ansari, Aachen (DE); Alexandros Palaios, Moers (DE); Vijaya Yajnanarayana, Bangalore (IN)

(21) Appl. No.: 19/099,370

(22) PCT Filed: Oct. 14, 2022
(86) PCT No.: PCT/EP2022/078692

§ 371 Date: Jan. 28, 2025

(30) Foreign Application Priority Data
Jul. 29, 2022 (GR) 20220100617

(51) Int. Cl. H04L 27/26; H04W 72/044

(52) U.S. Cl. CPC H04L 27/2656; H04W 72/044

(57) ABSTRACT

Network equipment (20) in a communication network (10) jointly adapts time division duplexing, TDD, patterns of 2024/022598 respective cells (16) in the communication network (10), based on performance (40) of the TDD patterns (30) in combination. Based on the adapted TDD patterns (30), the network equipment (20) jointly schedules communication devices (11) served by the cells (16). In some embodiments, joint TDD pattern adaptation is performed in an outer closed loop whereas the joint scheduling is performed in an inner closed loop, e.g., that operates on a faster timescale than the outer closed loop.

### TECHNICAL FIELD

The present application relates generally to a communication network, and relates more particularly to time division duplexing pattern adaptation in such a network.

### BACKGROUND

In Time-Division-Duplexing (TDD) operation of a wireless communication network, the same frequency band is used for uplink and downlink transmissions. A radio frame is divided into uplink and downlink subframes and they are time-multiplexed within the radio frame.

In a semi-static TDD network, such as a Long Term Evolution (LTE) network, a cell can be flexibly configured with any TDD pattern included in a predefined subset of TDD patterns. The TDD patterns in the predefined subset offer different ratios of uplink and downlink subframes, for handling variations in uplink traffic demand versus downlink traffic demand. Still, the TDD patterns in the preconfigured subset provide some level of harmonization and synchronization among different cells using potentially different TDD patterns, e.g., all TDD patterns in the subset start with a downlink subframe, followed by a special subframe and then an uplink subframe.

By contrast, in a dynamic TDD (D-TDD) network, such as a New Radio (NR) network, the TDD patterns usable are not limited to a predefined subset of TDD patterns. Instead, a cell has full flexibility to use any possible TDD pattern, so that the TDD pattern can be dynamically tailored to instantaneous traffic demands and/or application behavior. Dynamic TDD therefore improves spectrum utilization efficiency and reduces latency.

However, in D-TDD, the TDD patterns are heretofore independently selected for use by different cells, without any regard to harmonization or synchronization of different cells'TDD patterns. Increased flexibility to handle varying traffic conditions therefore comes at the expense of potentially increased inter-cell interference.

Challenges exist therefore in exploiting D-TDD for full TDD pattern flexibility while at the same time minimizing inter-cell interference. Unmitigated inter-cell interference threatens to increase latency (due to re-transmissions) and degrade throughput (due to poor signal quality), whereas non-optimal TDD patterns increase latency by increasing the total waiting period for downlink or uplink slots to occur. These challenges prove particularly problematic in mission-critical applications and industrial internet-of-things (IoT) where quality of service (QOS) requirements are stringent, e.g., low, bounded latency and very high reliability.

### SUMMARY

Embodiments herein jointly adapt time division duplexing (TDD) patterns of respective cells in a communication network, based on performance of the TDD patterns in combination, e.g., as characterized by inter-cell interference, sum throughput, and/or traffic latency. Furthermore, based on the adapted TDD patterns, some embodiments jointly schedule communication devices served by the cells. In one such embodiment, the TDD patterns are jointly adapted in an outer closed loop and the communication devices are jointly scheduled in an inner closed loop. Exploiting nested closed loops in this way advantageously decouples the timing of the joint TDD pattern adaptation from the timing of the joint scheduling, e.g., so that TDD patterns can be jointly adapted less often than the communication devices are jointly scheduled, resulting in less signaling overhead. Regardless, jointly adapting TDD patterns in this way may advantageously enable cells of the communication network to retain flexibility and autonomy over their respective TDD patterns while also mitigating the impact of the inter-cell interference on latency and throughput. Some embodiments may thereby be particularly applicable for exploiting dynamic TDD with low latency in mission-critical applications or industrial internet-of-things (IoT).

More particularly, embodiments herein include a method performed by network equipment in a communication network. The method comprises jointly adapting time division duplexing, TDD, patterns of respective cells in the communication network, based on performance of the TDD patterns in combination. The method also comprises, based on the adapted TDD patterns, jointly scheduling communication devices served by the cells.

In some embodiments, the TDD patterns are jointly adapted less often than the communication devices are jointly scheduled.

In some embodiments, the TDD patterns are jointly adapted in an outer closed loop and the communication devices are jointly scheduled in an inner closed loop, wherein a metric characterizing the performance of the TDD patterns in combination is an input to the outer closed loop, and wherein the adapted TDD patterns are an output of the outer closed loop and are an input to the inner closed loop.

In some embodiments, jointly adapting the TDD patterns comprises selecting, from different candidate combinations of TDD patterns, a combination of TDD patterns with which to configure the respective cells, based on respective performances of the candidate combinations of TDD patterns. Jointly scheduling the communication devices may also comprise selecting, from different candidate combinations of schedules in the cells, as configured with the selected combination of TDD patterns, a combination of schedules with which to schedule communication devices served by the cells. Here, a schedule in a cell may indicate resources allocated across communication devices served by the cell and/or parameters for transmission to and/or from communication devices served by the cell. In some embodiments, selecting the combination of TDD patterns may comprise computing, for each of the candidate combinations of TDD patterns, a cumulative reward achievable by the candidate combination as a function of a metric characterizing the performance of the TDD patterns in the candidate combination. In this case, said selecting also comprises selecting, from among the candidate combinations of TDD patterns, the candidate combination for which the cumulative reward computed is maximum.

In some embodiments, jointly adapting the TDD patterns comprises jointly adapting the TDD patterns based on a metric characterizing the performance of the TDD patterns in combination. In some embodiments, the metric characterizes the performance as a function of at least interference between the cells as configured with the TDD patterns. In other embodiments, the metric alternatively or additionally characterizes the performance as a function of at least sum-throughput of the cells as configured with the TDD patterns. In yet other embodiments, the metric alternatively or additionally characterizes the performance as a function of at least traffic latency in the cells as configured with the TDD patterns.

In some embodiments, jointly adapting the TDD patterns comprises jointly adapting the TDD patterns based on a metric characterizing the performance of the TDD patterns in combination. In some embodiments, the metric characterizes the performance as a function of interference measured by sensors deployed in respective coverage areas of the cells. In some embodiments, at least some of the sensors are deployed at fixed locations, are dedicated to measuring interference, and/or are configured to measure interference during times or under conditions that the communication devices are unable to measure interference.

In some embodiments, jointly adapting the TDD patterns comprises jointly adapting the TDD patterns based on a metric characterizing the performance of the TDD patterns in combination, subject to a requirement that adaptation of the TDD patterns must improve performance of the TDD patterns in combination by at least a margin, as characterized by the metric.

In some embodiments, the method further comprises adapting the margin as a function of at least quality of service requirements for traffic in the cells, respective numbers of communication devices in the cells, and/or resources available in the cells.

In some embodiments, jointly adapting the TDD patterns comprises jointly adapting the TDD patterns also based on characteristics of traffic in the respective cells.

In some embodiments, jointly scheduling the communication devices comprises jointly allocating resources across the communication devices. In other embodiments, jointly scheduling the communication devices alternatively or additionally comprises adapting parameters for transmission to and/or from the communication devices. In this case, allocating resources comprises allocating resources in a time domain, a frequency domain, and/or a spatial domain.

In some embodiments, jointly scheduling the communication devices comprises jointly scheduling the communication devices based on information characterizing how close each communication device is to an edge of the cell serving that communication device. In some embodiments, jointly scheduling the communication devices based on information characterizing how close each communication device is to an edge of the cell serving that communication device comprises jointly allocating resources across the communication devices by preferentially allocating, to communication devices that the information characterizes as being located close to the respective edges of the cells serving the communication devices, resources that are separated by at least a defined distance in a frequency domain and/or a spatial domain. In other embodiments, jointly scheduling the communication devices based on information characterizing how close each communication device is to an edge of the cell serving that communication device additionally or alternatively comprises jointly adapting parameters for transmission to and/or from the communication devices by preferentially configuring communication devices that the information characterizes as being located close to the respective edges of the cells serving the communication devices with higher transmit power, lower modulation order, and/or lower channel coding rate than communication devices that the information characterizes as being not located close to the respective edges of the cells serving the communication devices.

In some embodiments, jointly scheduling the communication devices comprises jointly scheduling the communication devices based also on mobility characteristics of the respective communication devices. In some embodiments, the mobility characteristics of a communication device characterize whether the communication device is mobile or stationary.

In some embodiments, at least some of the cells are provided by different access network nodes in the communication network.

In some embodiments, the communication network is an industrial internet-of-things network, and at least some of the cells provide communication coverage for different factory halls.

Other embodiments herein include network equipment configured for use in a communication network. The network equipment is configured to jointly adapt time division duplexing, TDD, patterns of respective cells in the communication network, based on performance of the TDD patterns in combination. In this case, the network equipment is also configured to, based on the adapted TDD patterns, jointly schedule communication devices served by the cells.

In some embodiments, network equipment is configured to perform the steps described above for network equipment.

Other embodiments herein include a computer program comprising instructions which, when executed by at least one processor of network equipment, causes the network equipment to perform the steps described above for network equipment.

In some embodiments, a carrier containing the computer program is one of an electronic signal, optical signal, radio signal, or computer readable storage medium.

Other embodiments herein include network equipment configured for use in a communication network. The network equipment comprises communication circuitry and processing circuitry. The processing circuitry is configured to jointly adapt time division duplexing, TDD, patterns of respective cells in the communication network, based on performance of the TDD patterns in combination. In this case the processing circuitry is also configured to, based on the adapted TDD patterns, jointly schedule communication devices served by the cells.

In some embodiments, the processing circuitry configured to perform the steps described above for network equipment.

### BRIEF DESCRIPTION OF THE DRAWINGS

FIG. 1 is a block diagram of a communication network with network equipment according to some embodiments.

FIG. 2 is a block diagram of network equipment with nested loops for joint TDD pattern adaptation and joint scheduling according to some embodiments.

FIG. 3 is a block diagram of joint scheduling of cell edge devices according to some embodiments.

FIG. 4 is a block diagram of inter-cell interference detection using sensors deployed in neighboring factory halls according to some embodiments.

FIG. 5 is a logic flow diagram of a method performed by network equipment according to some embodiments.

FIG. 6 is a block diagram of network equipment according to some embodiments.

FIG. 7 is a block diagram of a communication system in accordance with some embodiments.

FIG. 8 is a block diagram of a user equipment according to some embodiments.

FIG. 9 is a block diagram of a network node according to some embodiments.

FIG. 10 is a block diagram of a host according to some embodiments.

FIG. 11 is a block diagram of a virtualization environment according to some embodiments.

### DETAILED DESCRIPTION

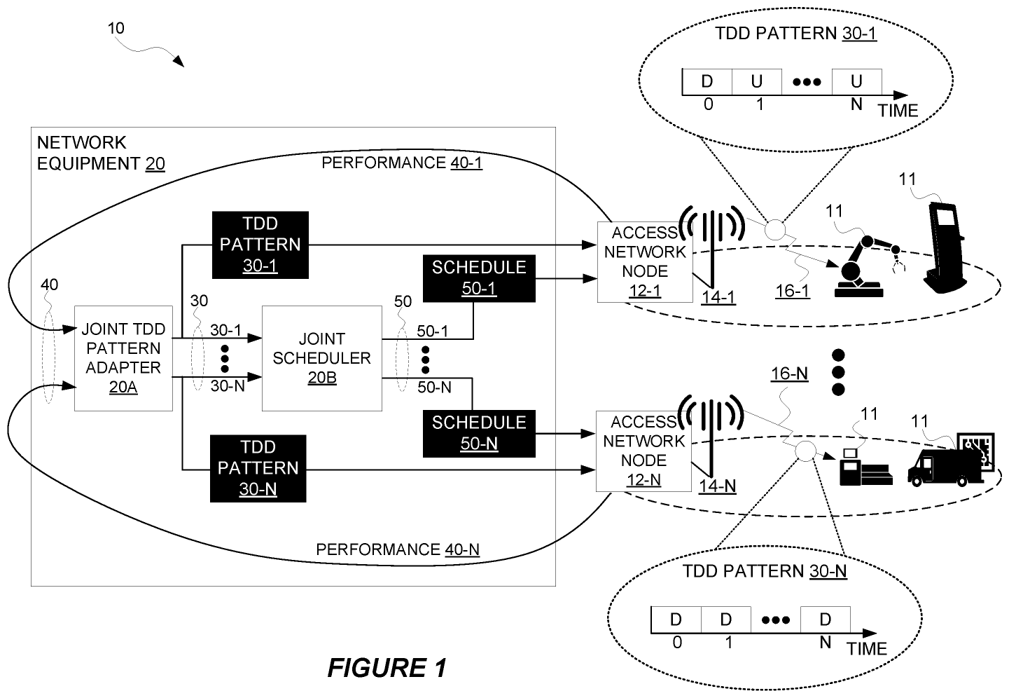

FIG. 1 shows a communication network 10 that provides communication service to communication devices 11. The communication network 10 in this regard includes one or more access network nodes 12-1 . . . 12-N, generally referred to as access network node(s) 12. Via associated antennas or remote radio heads 14-1 . . . 14-N, the access network node(s) 12 each provide one or more cells 16 on which to serve communication device(s) 11 within the coverage area of the respective cell(s) 16. Each cell 16 may be or be associated with a frequency carrier, e.g., with the cell's coverage area corresponding to the range of a reference signal or synchronization signal transmitted on the carrier. FIG. 1 for example shows access network node 12-1 provides cell 16-1 for serving communication device(s) 11 within the coverage area of that cell 16-1, and access network node 12-N provides cell 16-N for serving other communication device(s) 11 within the coverage area of that cell 16-N. Although not shown, in some embodiments, the same access network node 12 may provide two or more of the cells 16. In one or more embodiments, though, at least some of the cells 16 are provided by different access network nodes 12.

In some embodiments, for example, the communication network 10 is an industrial internet-of-things (IoT) network. In this case, the access network node(s) 12 may provide different cells 16, where at least some of the cells 16 provide communication coverage over different halls of a factory, with industrial Iot devices in the different factory halls being served by respective cells 16. The cells 16 in these and other embodiments, then, may be controlled by the same communication network operator.

Regardless, according to embodiments herein, the access network node(s) 12 perform transmission and reception in each of the cells 16 using time division duplexing (TDD). In TDD operation, uplink and downlink transmissions in a cell 16 are time-multiplexed, e.g., on the same frequency band. For example, the communication network 10 may structure radio resources usable for transmission into radio frames, with each radio frame divided into uplink and downlink subframes that are time-multiplexed within each radio frame. In these and other embodiments, a TDD pattern defines which times (e.g., which subframes within a radio frame) are usable for downlink transmission and which times (e.g., which subframes within a radio frame) are usable for uplink transmission.

As shown in the example of FIG. 1, for instance, downlink and uplink transmissions in each of the cells 16 is time-multiplexed within slots 0-N according to a respective TDD pattern, e.g., where one radio frame includes N slots. FIG. 1 shows that the TDD pattern 30-1 of cell 16-1 defines slot 0 as a downlink slot usable for downlink transmission, slot 1 as an uplink slot for uplink transmission, slot N as an uplink slot for uplink transmission, etc. By contrast, the TDD pattern 30-N of cell 16-N defines slot 0 as a downlink slot usable for downlink transmission, slot 1 as a downlink slot for downlink transmission, slot N as a downlink slot for downlink transmission, etc. Although illustrated with respect to slots, TDD patterns 30 may be defined in terms of any units of time, e.g., subframes. Generally, in the context of this example, the TDD patterns 30-1 . . . 30-N of the respective cells 16-1 . . . 16-N will be referred to for convenience as the TDD patterns 30 of the cells 16.

In some embodiments, the TDD patterns 30 of the respective cells 16 is dynamically adapted, as opposed to being semi-static. The dynamic nature of the TDD adaptation may mean, for instance, that the TDD patterns 30 of the respective cells 16 are adapted as needed to meet instantaneous traffic demand and/or other traffic characteristics in the cells. In these and other embodiments, the TDD patterns 30 may be adapted with full flexibility regarding which times are used for uplink transmission and which times are used for downlink transmission. For example, rather than the candidate TDD patterns usable by a cell 16 being limited to a predefined subset of candidate TDD patterns, where all candidate TDD patterns in the subset have certain slot(s) that must be used for downlink transmission and/or certain slot(s) that must be used for uplink transmission, the candidate TDD patterns usable by a cell 16 may extend to all possible TDD patterns. In this case, then, any slot can be used for downlink transmission and any slot can be used for uplink transmission.

In this context, network equipment 20 in FIG. 1 adapts the TDD patterns 30 of the cells 16 in the communication network 10. The network equipment 20 in particular includes a joint TDD pattern adapter 20A that jointly adapts the TDD patterns 30. Joint adaptation of the TDD patterns 30 means that the TDD patterns 30 of the cells 16 are adapted in combination, e.g., with the network equipment 20 considering the impact of the combination of the TDD patterns 30 across the cells 16, rather than only considering each cell's TDD pattern separately and individually. As shown in FIG. 1, for instance, the joint TDD pattern adapter 20A outputs a combination of TDD patterns 30 that includes TDD pattern 30-1 for cell 16-1, TDD pattern 30-N for cell 16-N, and so on. By jointly adapting the cells'TDD patterns 30 in this way, then, the network equipment 20 effectively coordinates the TDD patterns 30 across the cells 16.

More specifically in this regard, the network equipment 20 according to embodiments herein jointly adapts the TDD patterns 30 of the cells 16 based on performance 40 of the TDD patterns 30 in combination, e.g., based on a metric characterizing such performance 40. As shown in FIG. 1, for instance, the joint TDD pattern adapter 20A receives signaling from the access network node(s) 12 indicating individual performances 40-1 . . . 40-N of the respective TDD patterns 30-1 . . . 30-N in the cells 16-1 . . . 16-N, with the performance 40 of the TDD patterns 30 in combination being determinable from (e.g., a combination of) the individual performances 40-1 . . . 40-N of the TDD patterns 30. In these and other embodiments, for example, the performance 40 of the TDD patterns 30 in combination may be characterized as a function of the interference between the cells 16 as configured with the TDD patterns 30, the sum-throughput of the cells 16 as configured with the TDD patterns 30, the traffic latency in the cells 16 as configured with the TDD patterns 30, or some combination thereof. Regardless of the particular nature of the performance 40, the joint TDD pattern adapter 20A in some embodiments adapts the TDD patterns 30 of the cells 16 as needed to optimize the performance 40 of the TDD patterns 30 in combination, e.g., to minimize interference between the cells 16, to maximize the sum-throughput of the cells 16, to minimize the traffic latency in the cells 16, or to optimize some weighted combination thereof.

Note that the joint TDD pattern adapter 20A may jointly adapt the TDD patterns 30 of the cells 16 based on the combined performance 40 of the cells'TDD patterns 30 as well as based on one or more other factors, such as the characteristics of the traffic in the respective cells 16. For example, the network equipment 20 may jointly adapt the TDD patterns 30 as needed to optimize a metric characterizing the TDD patterns'combined performance 40, subject to satisfying traffic demand in each of the respective cells 16. In this case, the network equipment 20 may still ensure that the ratio of uplink and downlink slots is matched to or suitable for the application behavior and/or traffic variations in each cell, e.g., to optimize spectrum utilization efficiency and reduce latency.

In any event, the network equipment 20 in FIG. 1 also includes a joint scheduler 20B that jointly schedules communication devices 11 served by the cells 16. The joint scheduler 20B as shown in this regard outputs schedules 50-1 . . . 50-N for the respective cells 16-1 . . . 16-N, generally referred to as schedules 50. The schedule 50 in any given cell 16 schedules communication devices 11 served by that cell. For example, the schedule 50 in a cell 16 may indicate resources allocated across communication devices 11 served by the cell and/or parameters for transmission to and/or from communication devices 11 served by the cell.

The joint nature of the scheduling means that scheduling is performed for the cells 16 in combination, rather than scheduling for each cell 16 being performed separately and individually on a cell by cell basis. Jointly scheduling the communication devices 11 in some embodiments involve jointly allocating resources across the communication device 11. Such radio resources may for instance include radio resources for transmission to and/or from the communication devices 11, e.g., in a time domain, frequency domain, and/or a spatial domain. Alternatively or additionally, jointly scheduling the communication devices 11 may involve jointly adapting parameters for transmission to and/or from the communication devices 11, e.g., including a modulation and coding scheme (MCS) parameter, a block error rate target parameter, a transmit power parameter, or any other parameter for dynamic link adaptation. In either case, the joint scheduler 20B may jointly schedule the communication devices 11 as needed to meet quality of service (QOS) requirements of each communication device 11 and/or key performance indicator (KPI) targets for the communication network 10 as a whole. The joint scheduler 20B may do so as part of scheduling communication devices 11 in a way that has the least cost to total network interference yet still meets the QoS requirements and/or KPI targets.

Notably, the joint scheduler 20B jointly schedules the communication devices 11 based on the adapted TDD patterns 30. The joint scheduler 20B in this regard receives the adapted TDD patterns 30 as input and jointly schedules the communication devices 11 on the basis of the TDD patterns 30 as adapted. For examples, in embodiments where the TDD pattern 30 for each cell defines which slots are usable for downlink transmission in the cell and which slots are usable for uplink transmission in the cell, the joint scheduler 20B jointly schedules the communication devices 11 served by the cells 16 subject to the limitations in each cell 16 on which slots are usable for downlink transmission and which slots are usable for uplink transmission, i.e., following the TDD pattern 30 for each cell. Regardless, basing joint scheduling on the TDD patterns 30 as adapted means that scheduling is not performed jointly with the TDD pattern adaptation. Instead, scheduling and TDD pattern adaptation are effectively performed in separate stages or tiers, e.g., in a multi-stage or multi-tier optimization task.

One advantage of performing scheduling and TDD pattern adaptation in separate stages or tiers is that this allows scheduling and TDD pattern adaptation to be performed on separate timescales or time granularities. For example, in some embodiments, the network equipment 20 jointly adapts the TDD patterns 30 on a slower timescale than the timescale on which it jointly schedules the communication devices 11, such that the network equipment 20 jointly adapts the TDD patterns less often than it jointly schedules the communication devices 11. Adapting the TDD patterns 30 less often advantageously avoids excessive control signaling overhead in embodiments where the TDD patterns 30 are indicated to the access network nodes 12 or the cells 16 via semi-static control signaling, e.g., radio resource control (RRC) signaling. That is, some embodiments avoid frequent updates of the TDD patterns 30 in order to achieve low signaling overhead. And making joint scheduling decisions for the communication devices 11 more often advantageously adapts scheduling fast enough to track changes in traffic characteristics and/or channel conditions in the cells 16.

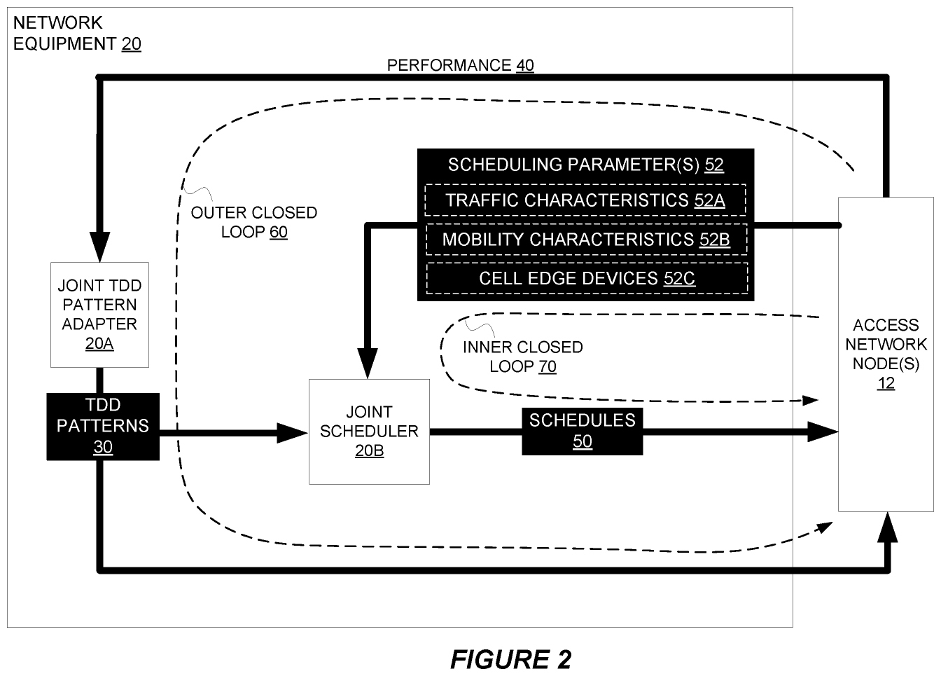

FIG. 2 shows one way to perform scheduling and TDD pattern adaptation in separate stages or tiers according to some embodiments; namely, using nested loops. As shown, the joint TDD pattern adapter 20A jointly adapts the TDD patterns 30 in an outer closed loop 60 and the joint scheduler 20B jointly schedules the communication devices 11 in an inner closed loop 70. In the outer closed loop 60, the joint TDD pattern adapter 20A receives as input a metric characterizing the performance 40 of the TDD patterns 30 in combination, jointly adapts the TDD patterns 30 of the cells 16 based on that metric, and outputs the TDD patterns 30 to the access network node(s) 12 providing the cells 16. The outer closed loop 60 in this regard updates the TDD patterns 30 that it provides to the inner closed loop 70 once each period of the outer closed loop 60, i.e., the TDD patterns 30 remain stable for the duration of the outer closed loop's period.

In the inner closed loop 70, the joint scheduler 20B receives, as input, the adapted TDD patterns 30 from the joint TDD pattern adapter 20A, i.e., from the outer closed loop 60. The joint scheduler 20B also receives as input one or more scheduling parameters 52. The scheduling parameter(s) 52 may for example include respective bandwidths of the cells 16, respective subcarrier spacings of the cells 16, respective beamwidths of the cells 16, respective beam directions of the cells 16, etc. As shown, the scheduling parameter(s) 52 may alternatively or additionally include a parameter indicating traffic characteristics 52A of the cells 16, e.g., in terms of traffic QoS requirements and/or traffic profiles indicating the ratio between uplink and downlink traffic in the cells 16. Regardless, based on the adapted TDD patterns 30 from the outer closed loop 60 and on the scheduling parameter(s) 52, the joint scheduler 20B jointly schedules the communication devices 11 in the cells 16 and provides the resulting schedules 50 as output to the access network node(s) 12 providing the cells 16, e.g., where the schedule 50 for each cell 16 indicates the resources and/or transmit parameters allocated to each user in the cell 16, with the cell 16 having the TDD pattern 30 that the outer closed loop 60 selected for the cell 16. Generally, then, the metric characterizing performance 40 of the TDD patterns 30 in combination is an input to the outer closed loop 60, and the adapted TDD patterns 30 are an output of the outer closed loop 60 and an input to the inner closed loop 70.

More particularly, in some embodiments, the joint TDD pattern adapter 20A selects the combination of TDD patterns 30 with which to configure the cells 16 during any given period of the outer closed loop 60 by selecting that combination of TDD patterns 30 from a set of candidate combinations of TDD patterns. In this case, the joint TDD pattern adapter 20A selects, from the different candidate combinations of TDD patterns, the combination of TDD patterns with which to configure the respective cells 16, based on respective performances of the candidate combinations of TDD patterns. In one such embodiment, the joint TDD pattern adapter 20A exploits machine learning (e.g., reinforcement learning) to learn and predict which candidate combination of TDD patterns is optimal to select during any given period of the outer closed loop 60. For example, the joint TDD pattern adapter 20A in some embodiments computes, for each of the candidate combinations of TDD patterns, a cumulative reward achievable by the candidate combination as a function of a metric characterizing the performance of the TDD patterns in the candidate combination. The joint TDD pattern adapter 20A in this case selects, from among the candidate combinations of TDD patterns, the candidate combination for which the cumulative reward computed is maximum.

Similarly, the joint scheduler 20B in some embodiments selects the combination of schedules 50 with which to schedule communication devices 11 in the cells 16 by selecting that combination of schedules 50 from different candidate combinations of schedules in the cells 16. The different candidate combinations of schedules in the cells 16 in this case are the combinations of schedules that are candidates given configuration of the cells 16 with the combination of TDD patterns selected by the joint TDD pattern adapter 20A.

Regardless, in this context, the outer closed loop 60 according to some embodiments has a longer duration or period than the duration or period of the inner closed loop 70, such that the TDD patterns 30 are selected by the outer closed loop 60 less frequently than the schedules 50 are selected by the inner closed loop 70. In other words, the inner closed loop 70 is faster than the outer closed loop 60.

Moreover, some embodiments herein also reduce how frequently the TDD patterns 30 are adapted by discouraging TDD pattern adaptation when the adaptation would not meaningfully improve the performance 40 of the TDD patterns 30 in combination. Some embodiments for example define a requirement that adaptation of the TDD patterns 30 must improve the performance 40 of the TDD patterns 30 in combination by at least a certain margin, as characterized by a metric. If the metric characterizes the performance 40 of the TDD patterns 30 in terms of inter-cell interference, for instance, the requirement specifies that adaptation of the TDD patterns 30 must reduce inter-cell interference by at least a certain margin. Otherwise, if adaptation of the TDD patterns 30 would reduce inter-cell interference but by an amount that is less than this margin, the TDD patterns 30 are not adapted, even though adaptation would in fact reduce inter-cell interference. Generally, then, the joint TDD pattern adapter 20A jointly adapts the TDD patterns 30 based on the metric characterizing the performance 40 of the TDD patterns 30 in combination, subject to the requirement that adaptation of the TDD patterns 30 must improve the performance 40 by at least the margin. In this case, the TDD patterns 30 are updated selectively when the current TDD patterns 30 turn out to be suboptimal by at least the margin. Effectively imposing a sort of hysteresis on TDD pattern adaptation in this way advantageously ensures TDD pattern stability, avoids excessive TDD pattern changes, and reduces control signaling overhead when the benefit of the TDD pattern adaptation would be marginal.

The margin that governs when TDD pattern adaptation is or is not justified may itself be adapted in some embodiments, e.g., as needed to reflect changing circumstances that impact the choice between increasing control signaling overhead and marginally improving TDD pattern performance 40. For example, in some embodiments, the margin may be adapted as a function of quality of service (QOS) requirements for traffic in the cells 16, e.g., traffic criticality. If for instance the QOS requirements become more stringent, the margin may be adapted so that the amount of performance improvement required to trigger TDD pattern adaptation is less, e.g., as part of a strategy to favor meeting QoS requirements even sometimes at the expense of increasing control signaling overhead. Alternatively or additionally, in other examples, the margin may be adapted as a function of the number of communication devices 11 in the cells, the resources available in the cells 16, resilience to interference, resilience to performance loss, amount of interference, etc. In any event, a larger margin allows less sensitivity to interference conditions and vice-versa.

In one specific implementation, the margin may be selected based on the traffic QoS requirements, number of UEs, suboptimality of the TDD patten, or any two or more parameters. One example is a weighting function T1=w1*P1+w2*P2+ . . . +wn*Pn where T1 is the margin, w is the normalized weighting factor and P is the parameter value like traffic QoS, number of UEs, mobility of a UE, etc.

Note, of course, that in some embodiments the performance 40 of the TDD patterns 30 in combination is impacted by the scheduling decisions of the inner closed loop 70. To the extent the performance 40 is characterized by the level of inter-cell interference, for example, the inter-cell interference level is impacted by the radio resources in which the joint scheduler 20B schedules communication devices 11 served by different cells 16. In this context, then, some embodiments herein target keeping the combination of TDD patterns 30 from the outer closed loop 60 stable over time as much as possible, and only adapt that combination of TDD patterns 30 when the inner closed loop 70 cannot schedule the communication devices 11 in a way that maintains the TDD pattern combination's optimality over a different TDD pattern combination. For example, given a current combination of TDD patterns 30 selected by the outer closed loop 60, the inner closed loop 70 aims to allocate radio resources to communication devices 11 and/or set transmit parameters for the communication devices 11 in a manner that optimizes the resource usage and minimizes inter-cell interference. When the current combination of TDD patterns 30 is no longer optimal and another combination of TDD patterns 30 would achieve better performance 40 (e.g., lower inter-cell interference), the outer closed loop 60 selects that other, more-optimal combination of TDD patterns 30 if it would provide more than a marginal performance improvement over the current combination of TDD patterns 30.

In these and other embodiments, the scheduling parameter(s) 52 may assist the joint scheduler 20B to make scheduling decisions that improve performance 40. In one embodiment, for example, the scheduling parameter(s) 52 indicate information 52B about the mobility characteristics of the communication devices 11. The mobility characteristics of a communication device 11 may for example characterize whether the communication device 11 is mobile or stationary. In one such embodiment, the information 52B may be, or be included in, “UE assistance information” as defined in 3GPP Technical Specification (TS) 38.331 v17.1.0, to indicate to the joint scheduler 20B the type of device mobility, e.g., whether the communication device is mounted on a mobile sensor, is a mobile robot, is an automated guided vehicle, is statically positioned, is associated with a person, etc. In these and other embodiments, the mobility characteristics may assist the joint scheduler 20B in scheduling the communication devices 11 with radio resources and/or transmit parameters that are appropriate for how much and/or how often the communication devices move, to in turn reduce the overall inter-cell interference in the communication network 10.

Note in this regard that dynamic, mobile devices are more prone to receiving interference and causing interference while static devices can be planned more easily. Mobile robots, machines, and workers going towards the cell edge have to be treated more pessimistically for link robustness, and disjoint resource allocations have to be ensured for them compared to static devices. One example is that an AGV (automated guided vehicle) which can go towards the cell edge is given resources which are non-overlapping to other cell edge devices. Similarly, the mission critical traffic is sent more robustly for such an AGV.

Alternatively or additionally, the scheduling parameter(s) 52 may indicate information 52C characterizing how close each communication device 11 is to an edge of the cell 16 serving that communication device 11. The information 52C may for example include positions of the communication devices 11, measurement reports from the communication devices 11, respective serving cells of the communication devices 11, and/or other information from which the joint scheduler 20B can deduce or detect how close each communication device 11 is to its serving cell. Regardless, the joint scheduler 20B in this case may jointly schedule the communication devices 11 taking into account which of the communication devices 11 are located close to the respective edges of their serving cells 16, with such devices being referred to as cell edge devices. For cell edge devices scheduled in the same time resource, for example, the joint scheduler 20B may schedule those cell edge devices with radio resources that are at least well-separated in space and/or frequency, e.g., well-separated frequency resources and/or well-separated beamwidths and/or beam directions. Alternatively or additionally, the joint scheduler 20B may schedule those cell edge devices with higher transmit power, lower modulation code, and/or lower channel coding rate. Scheduling cell edge devices in these or other ways may advantageously reduce the overall inter-cell interference in the communication network 10.

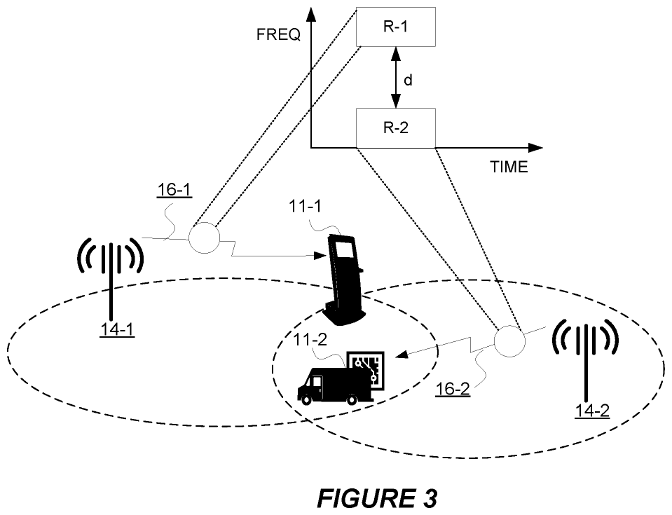

FIG. 3 shows one example. As shown, the joint scheduler 20B detects that communication devices 11-1 and 11-2 are located close to the edges of their respective serving cells 16-1 and 16-2. The joint scheduler 20B in this case schedules these cell edge devices 11-1, 11-2 with respective radio resources R-1 and R-2, taking into account the cell edge nature of the devices 11-1, 11-2. The radio resources R-1, R-2 here overlap in time, but are separated by a distance d in frequency that is at least a minimum threshold distance defined for separating cell edge devices. Since the transmit power of the uplink transmissions from the communication devices 11-1, 11-2 will be high, given their location at the cell edge, this frequency separation will minimize the interference that would otherwise result if the resources R-1, R-2 had overlapped also in frequency.

Generally, then, as this example demonstrates, the joint scheduler 20B in some embodiments jointly allocates resources across the communication devices 11 by preferentially allocating, to communication devices 11 characterized as being located close to the respective edges of the cells 16 serving the communication devices 11, resources that are separated by at least a defined distance in a frequency domain and/or a spatial domain. Although not shown, the joint scheduler 20B may alternatively or additionally jointly adapt parameters for transmission to and/or from the communication devices 11 by preferentially configuring communication devices 11 characterized as being located close to the respective edges of the cells 16 serving the communication devices 11 with higher transmit power, lower modulation order, and/or lower channel coding rate than communication devices 11 characterizes as being not located close to the respective edges of the cells 16 serving the communication devices 11.

The joint scheduler 20B herein may thereby exploit any number of scheduling parameters 52 for making its joint scheduling decisions. Indeed, the joint scheduler 20B may make its joint scheduling decisions based on the nature of the communication devices as being cell edge devices or not. The joint scheduler 20B may alternatively or additionally make its joint scheduling decisions based on traffic characteristics in the cells 16, taking into account any deterministic component (due to periodical changes in the traffic characteristics such as time of day), any variable component (due to for example background traffic for updates, etc.), and/or any physical layer ‘reality’ (i.e., retransmissions which add further variability). Alternatively or additionally, the joint scheduler 20B may make its joint scheduling decisions based on the signal-to-noise-plus-interference ratios (SINR) measured for the respective communication devices 11 and/or based on the respective modulation and coding schemes (MCSs) appropriate for the communication devices 11. Moreover, the joint scheduler 20B may make its joint scheduling decisions taking into account the spatial separation of communication devices 11 (i.e., their respective radio environments) and/or the separation in the radio signal dimension (e.g., precoding using).

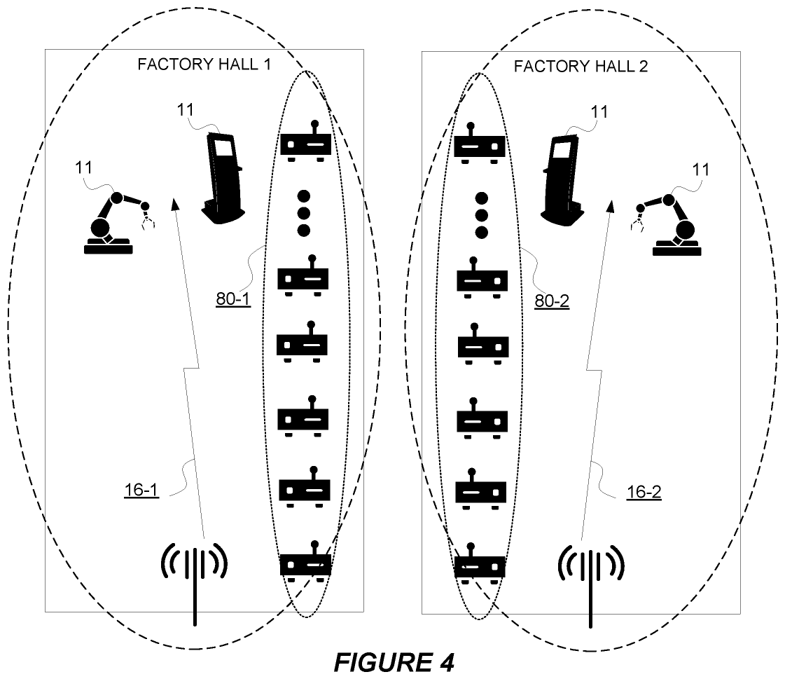

Note that, in embodiments where the performance 40 of the TDD patterns 30 in combination is a function of interference, that interference may be detected or quantified in any number of ways. Some embodiments in this regard exploit sensors deployed in the respective coverage areas of the cells 16, e.g., in the form of spectrum sensors that measure interference in terms of energy levels, power spectral density, or the like. FIG. 4 shows one example in a context where different cells 16-1, 16-2 cover respective factory halls 1 and 2. As shown, different sets 80-1, 80-2 of sensors detect inter-cell interference for respective cells 16-1, 16-2, i.e., with sensors in set 80-1 detecting inter-cell interference experienced in cell 16-1 and sensors in set 80-2 detecting inter-cell interference experienced in cell 16-2. In some embodiments, the sensors in each set characterize inter-cell interference in terms of a combination of interference measurements performed by respective sensors in the set, e.g., such that the combination of interference measurements across the sensors in the set serves as a signature or fingerprint of the interference.

In some embodiments, the sensors in the set for a cell perform measurements of the interference in the same frequency band as that used by the cell and/or outside of the frequency band used by the cell. Indeed, in some embodiments, interference measurements performed by the sensors in the set may be performed in an out-of-band frequency range that is out of the frequency band(s) used by the cell for communication with its served communication devices 11, e.g., such that the interference measurements may effectively sample the inter-cell interference. In these and other embodiments, the sensors in the set are not themselves communication devices 11 served by the cell, as the communication devices 11 may only be capable of measuring and reporting interference on time-frequency resources used for communication service from the cell. Rather, the sensors in the set may in some embodiments be dedicated to performing measurements for characterizing inter-cell interference. Generally, then, the sensors may be configured to measure interference during times or under conditions that communication devices 11 are unable to measure interference.

Alternatively or additionally, in some embodiments, at least some of the sensors in the set for a cell are deployed at fixed locations within the cell's coverage area. This way, the network equipment 20 can understand the inter-cell interference measured by the set of sensors at any given time as being attributable to changes in the interference levels, e.g., as opposed to changes in the location of the sensors. In other embodiments, though, at least some of the sensors in the set may be deployed at locations known to the network equipment 20, so that the network equipment 20 can interpret the inter-cell interference measured by the set of sensors at any given time as a function of the sensors'respective locations at that time.

Note that the network equipment 20 herein performs joint TDD pattern adaptation and joint scheduling for multiple cells 16, where those cells 16 may be all of the cells in the communication network 10 or a subset of the cells in the communication network 10. In embodiments where the network equipment 20 performs joint TDD pattern adaptation and joint scheduling for a subset of cells, different network equipment may perform joint TDD pattern adaptation and joint scheduling for different respective subset of cells in the communication network 10.

Note also that the network equipment 20 herein may be any equipment in the communication network 10 that is capable of obtaining relevant information about the multiple cells 16 for which it performs joint TDD pattern adaptation and joint scheduling. The network equipment 20 in one embodiment, for example, may be one of the access network node(s) 12 that provides one or more of the multiple cells 16, in which case the network equipment 20 may receive the relevant information (e.g., over an inter-node interface) for one or more others of the multiple cells 16 from one or more other access network node(s) 12 that provide the other cell(s) 16. In other embodiments, by contrast, the network equipment 20 is central equipment (e.g., in the access network or core network) that does not itself provide any of the multiple cells 16 but that is communicatively connected to the access network node(s) 12 that provide the cells 16.

Some embodiments herein are applicable for mission-critical applications such as industrial automation scenarios and robotic control applications. Indeed, in these applications, the QoS requirements must be fulfilled for individual communication devices connected to sensors, controllers (e.g., programmable logic controllers, PLCs), or actuators (e.g., robots, machining tools, etc.), requiring essentially bounded latency with a very high degree of reliability. In practical deployments, multiple factory halls belonging to the same owner may be located nearby, such that each factory hall suffers from spectrum interference from any nearby factory halls. In this case, using the identical synchronized TDD pattern across factory halls would mitigate interference, this approach would be highly suboptimal and would not address potentially different traffic demands in the close-by factory halls. Some embodiments herein by contrast adapt TDD patterns for the factory halls based on the dynamic traffic demands of those factory halls, to adequately address the traffic characteristics of the use-cases in the specific factory halls.

In this context, some embodiments herein provide a framework that allows mutual sharing of information between different factory halls, and exploitation of that shared information to dynamically assign appropriate TDD patterns and optimize resources for the respective factory halls. Furthermore, embodiments that exploit sensors apart from the communication devices 11 to detect inter-cell interference, as part of characterizing the performance 40 of the TDD patterns 30 in combination, overcome existing channel feedback mechanisms that prove inadequate for detecting interference in out-of-band frequencies. Some embodiments moreover provide a coordination scheme amongst cells that can utilize properly the characteristics of the industrial traffic, and thereby select the TDD pattern and resource usage appropriately in order to mitigate interference.

Some embodiments herein generally provide the capability to optimize two or more different variables which need to be handled at different rates. For example, the mobility of UEs result in faster rate of changes which needs faster adaptation in the resource allocation compared to a single loop for both TDD adaptation and resource allocation. The single rate of such a single loop would not fit use-cases requiring a high degree of dynamism and adaptation, e.g., for taking into account traffic patterns of each individual communication device 11, also referred to as traffic profile herein. The multi-loop framework of some embodiments herein thereby enables faster dynamic scheduling as needed to better manage residual interference remaining after TDD pattern adaptation.

Furthermore, some embodiments herein better handle high mobility scenarios where communication devices are in and out of cell edge. Indeed, the latency characteristics for the cell-edge devices are, in particular, dependent on the link adaptation (LA) parameters like the MCS (modulation coding scheme) and the physical resource block (PRB) usage. Assigning cell edge users a BLER (block error rate) target similar to other users would cause cell edge users to end up having more optimistic MCS than appropriate, resulting in packet losses due to interference, which would in turn result in a penalty of added latency. Embodiments herein allow the cell edge devices, in particular, to select more robust MCS and hence to sustain interference, which results in effectively lower latency. Some embodiments further enable resource selection based on the traffic types, i.e., traffic with high degree of QoS requirements are allocated more resources (cf. pessimistic BLER targets) thus enabling better resilience to interference.

Some embodiments more particularly configure Cell edge devices with more robust transmission parameters. This may include higher transmit power levels for better SINR as part of the transmit power control scheme. This may alternatively or additionally involve ‘capping’ or restricting the MCS values for the cell edge devices so as to allow to keep transmissions more robust even with occasional/sporadic SINR peaks representing more optimistic channel conditions than reality. Potentially, lower BLER targets can be selected for critical traffic at the edge devices, which would lead to lower MCS values and make transmissions more robust. Alternatively or additionally, fragmentation can be used for larger packet sizes at edge devices, to have effectively better transmission success.

Furthermore, since cell-edge devices are susceptible to interreference, some embodiments improve their SINR by making sure that the transmissions from the neighbor cells towards its served devices which are in proximity to the cell-edge devices are non-overlapping in time/frequency. Some embodiments enable this through centralization of the scheduler.

Generally, some embodiments herein provide a two-tier framework (via nested closed loops) that exploits information from multiple cells. With this framework, TDD patterns can be selected for two or more different cells, with the TDD patterns selected to match the traffic requirements of the cells as well as to mitigate inter-cell interference. Moreover, some embodiments herein select the radio resources and link adaptation parameters based on the QOS service classes, and the degree of interference encountered. One implication is that as the edge devices that are more exposed to interference are configured with more robust MCS selection that provides resilience against interference. Some embodiments also make use of spectrum sensors for more informed interference handling and exchange of information among different cells. Some embodiments thereby enable the coordination of TDD pattern selection for multiple neighboring cells, and/or efficient PRB allocation that protects cell-edge devices. Also, some embodiments support critical traffic requirements for meeting very demanding QoS targets and/or are applicable to scenarios where the communication network 10 has several low-cost devices where device beam forming cannot be done effectively.

Advantageously, then, some embodiments enable a practically viable solution for coordination of the TDD pattern selection for nearby multiple cell sites (cf. factory halls) suffering from mutual spectrum interference. Some embodiments also cater the adjacent channel interference from another network in the vicinity.

Alternatively or additionally, some embodiments herein provide optimized TDD pattern selection of multiple sites to address the application's QoS requirements in each cell, especially for mission-critical industrial automation applications. Benefits include reduced latency, enhanced reliability and desirable throughput for the users located at different sites. Interference minimization and efficient use of spectral resources for specific cells, across multiple sites, leads to overall improvement of key KPIs in the neighboring networks.

Some embodiments enable efficient Physical Resource Block (PRB) allocation, specifically protecting cell-edge devices. This allows meeting the QoS targets of mission critical traffic (requiring low latency and high reliability), which would otherwise suffer from interference issues.

Some embodiments optimize nearby multi-site deployment setup to cater the dynamics in the radio environment and address individual dynamic traffic characteristics. Alternatively or additionally, some embodiments enabling cooperation between different owners for mutually reducing interference and improving performance across sites.

Some embodiments herein are applicable to the scenario where the network has several cheaper devices where device beam forming cannot be done effectively. In this case, some embodiments herein can be beneficial as the PRB allocations are well separated and their omni-directional transmission does not impact the neighbor cells much, thereby reducing the interference.

Some embodiments exploit external spectrum sensors so as to enhance the capabilities of the communication network 10 without causing any standard impact.

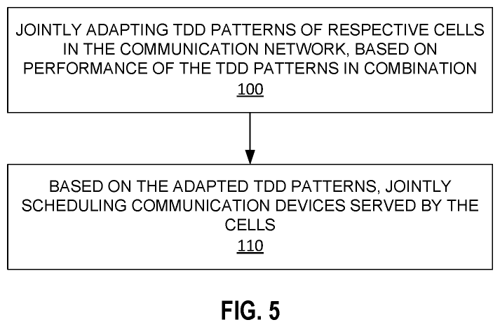

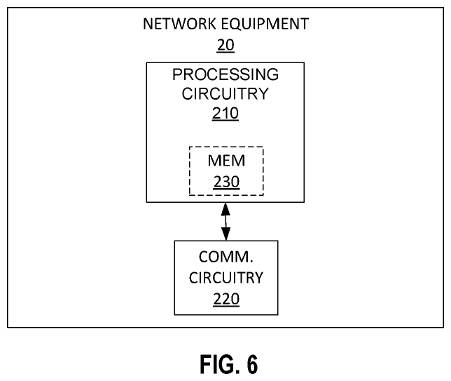

In view of the modifications and variations herein, FIG. 5 depicts a method in accordance with particular embodiments. The method is performed by network equipment 20 in a communication network 10. The method includes jointly adapting TDD patterns 30 of respective cells 16 in the communication network 10, based on performance 40 of the TDD patterns 30 in combination (Block 100). The method also includes, based on the adapted TDD patterns 30, jointly scheduling communication devices 11 served by the cells 16 (Block 110).

In some embodiments, the TDD patterns 30 are jointly adapted less often than the communication devices 11 are jointly scheduled.

In some embodiments, the TDD patterns 30 are jointly adapted in an outer closed loop 60 and the communication devices 11 are jointly scheduled in an inner closed loop 70, wherein a metric characterizing the performance 40 of the TDD patterns 30 in combination is an input to the outer closed loop 60, and wherein the adapted TDD patterns 30 are an output of the outer closed loop 60 and are an input to the inner closed loop 70.

In some embodiments, jointly adapting the TDD patterns 30 comprises selecting, from different candidate combinations of TDD patterns 30, a combination of TDD patterns 30 with which to configure the respective cells 16, based on respective performances of the candidate combinations of TDD patterns 30. Jointly scheduling the communication devices 11 may also comprise selecting, from different candidate combinations of schedules in the cells 16, as configured with the selected combination of TDD patterns 30, a combination of schedules with which to schedule communication devices 11 served by the cells 16. Here, a schedule in a cell may indicate resources allocated across communication devices 11 served by the cell and/or parameters for transmission to and/or from communication devices 11 served by the cell. In some embodiments, selecting the combination of TDD patterns 30 may comprise computing, for each of the candidate combinations of TDD patterns 30, a cumulative reward achievable by the candidate combination as a function of a metric characterizing the performance 40 of the TDD patterns 30 in the candidate combination. In this case, said selecting also comprises selecting, from among the candidate combinations of TDD patterns 30, the candidate combination for which the cumulative reward computed is maximum.

In some embodiments, jointly adapting the TDD patterns 30 comprises jointly adapting the TDD patterns 30 based on a metric characterizing the performance 40 of the TDD patterns 30 in combination. In some embodiments, the metric characterizes the performance 40 as a function of at least interference between the cells 16 as configured with the TDD patterns 30. In other embodiments, the metric alternatively or additionally characterizes the performance 40 as a function of at least sum-throughput of the cells 16 as configured with the TDD patterns 30. In yet other embodiments, the metric alternatively or additionally characterizes the performance 40 as a function of at least traffic latency in the cells 16 as configured with the TDD patterns 30.

In some embodiments, jointly adapting the TDD patterns 30 comprises jointly adapting the TDD patterns 30 based on a metric characterizing the performance 40 of the TDD patterns 30 in combination. In some embodiments, the metric characterizes the performance 40 as a function of interference measured by sensors deployed in respective coverage areas of the cells 16. In some embodiments, at least some of the sensors are deployed at fixed locations, are dedicated to measuring interference, and/or are configured to measure interference during times or under conditions that the communication devices 11 are unable to measure interference.

In some embodiments, jointly adapting the TDD patterns 30 comprises jointly adapting the TDD patterns 30 based on a metric characterizing the performance 40 of the TDD patterns 30 in combination, subject to a requirement that adaptation of the TDD patterns 30 must improve performance 40 of the TDD patterns 30 in combination by at least a margin, as characterized by the metric.

In some embodiments, the method further comprises adapting the margin as a function of at least quality of service requirements for traffic in the cells 16, respective numbers of communication devices 11 in the cells 16, and/or resources available in the cells 16.

In some embodiments, jointly adapting the TDD patterns 30 comprises jointly adapting the TDD patterns 30 also based on characteristics of traffic in the respective cells 16.

In some embodiments, jointly scheduling the communication devices 11 comprises jointly allocating resources across the communication devices 11. In other embodiments, jointly scheduling the communication devices 11 alternatively or additionally comprises adapting parameters for transmission to and/or from the communication devices 11. In this case, allocating resources comprises allocating resources in a time domain, a frequency domain, and/or a spatial domain.

In some embodiments, jointly scheduling the communication devices 11 comprises jointly scheduling the communication devices 11 based on information characterizing how close each communication device is to an edge of the cell serving that communication device. In some embodiments, jointly scheduling the communication devices 11 based on information characterizing how close each communication device is to an edge of the cell serving that communication device comprises jointly allocating resources across the communication devices 11 by preferentially allocating, to communication devices 11 that the information characterizes as being located close to the respective edges of the cells 16 serving the communication devices 11, resources that are separated by at least a defined distance in a frequency domain and/or a spatial domain. In other embodiments, jointly scheduling the communication devices 11 based on information characterizing how close each communication device is to an edge of the cell serving that communication device additionally or alternatively comprises jointly adapting parameters for transmission to and/or from the communication devices 11 by preferentially configuring communication devices 11 that the information characterizes as being located close to the respective edges of the cells 16 serving the communication devices 11 with higher transmit power, lower modulation order, and/or lower channel coding rate than communication devices 11 that the information characterizes as being not located close to the respective edges of the cells 16 serving the communication devices 11.

In some embodiments, jointly scheduling the communication devices 11 comprises jointly scheduling the communication devices 11 based also on mobility characteristics of the respective communication devices 11. In some embodiments, the mobility characteristics of a communication device characterize whether the communication device is mobile or stationary.

In some embodiments, at least some of the cells 16 are provided by different access network nodes in the communication network 10.

In some embodiments, the communication network is an industrial internet-of-things network, and at least some of the cells 16 provide communication coverage for different factory halls.

Embodiments herein also include corresponding apparatuses. Embodiments herein for instance include network equipment 20 configured to perform any of the steps of any of the embodiments described above for the network equipment 20.

Embodiments also include network equipment 20 comprising processing circuitry and power supply circuitry. The processing circuitry is configured to perform any of the steps of any of the embodiments described above for the network equipment 20. The power supply circuitry is configured to supply power to the network equipment 20.

Embodiments further include a network equipment 20 comprising processing circuitry. The processing circuitry is configured to perform any of the steps of any of the embodiments described above for the network equipment 20. In some embodiments, the network equipment 20 further comprises communication circuitry.

Embodiments further include network equipment 20 comprising processing circuitry and memory. The memory contains instructions executable by the processing circuitry whereby the network equipment 20 is configured to perform any of the steps of any of the embodiments described above for the network equipment 20.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

Figure YY2 illustrates network equipment 20 as implemented in accordance with one or more embodiments. As shown, the network equipment 20 includes processing circuitry 210 and communication circuitry 220. The communication circuitry 220 is configured to transmit and/or receive information to and/or from other equipment, e.g., via any communication technology. The processing circuitry 210 is configured to perform processing described above, e.g., in FIG. 5, such as by executing instructions stored in memory 230. The processing circuitry 210 in this regard may implement certain functional means, units, or modules.

Those skilled in the art will also appreciate that embodiments herein further include corresponding computer programs.

A computer program comprises instructions which, when executed on at least one processor of network equipment 20, cause the network equipment 20 to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of network equipment 20, cause the network equipment 20 to perform as described above.

Embodiments further include a computer program product comprising program code portions for performing the steps of any of the embodiments herein when the computer program product is executed by network equipment 20. This computer program product may be stored on a computer readable recording medium.

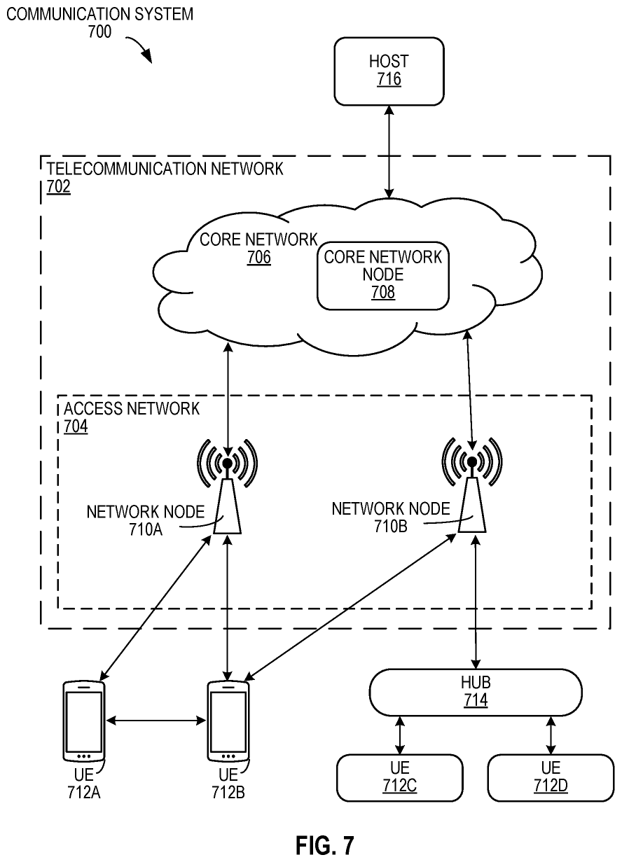

FIG. 7 shows an example of a communication system 700 in which network equipment 20 may be deployed accordance with some embodiments.

In the example, the communication system 700 includes a telecommunication network 702 that includes an access network 704, such as a radio access network (RAN), and a core network 706, which includes one or more core network nodes 708. The access network 704 includes one or more access network nodes, such as network nodes 710a and 710b (one or more of which may be generally referred to as network nodes 710), or any other similar 3^{rd} Generation Partnership Project (3GPP) access node or non-3GPP access point. The network nodes 710 facilitate direct or indirect connection of user equipment (UE), such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular in if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710b. In other embodiments, the hub 714 may be a non-dedicated hub—that is, a device which is capable of operating to route communications between the UEs and network node 710b, but which is additionally capable of operating as a communication start and/or end point for certain data channels.

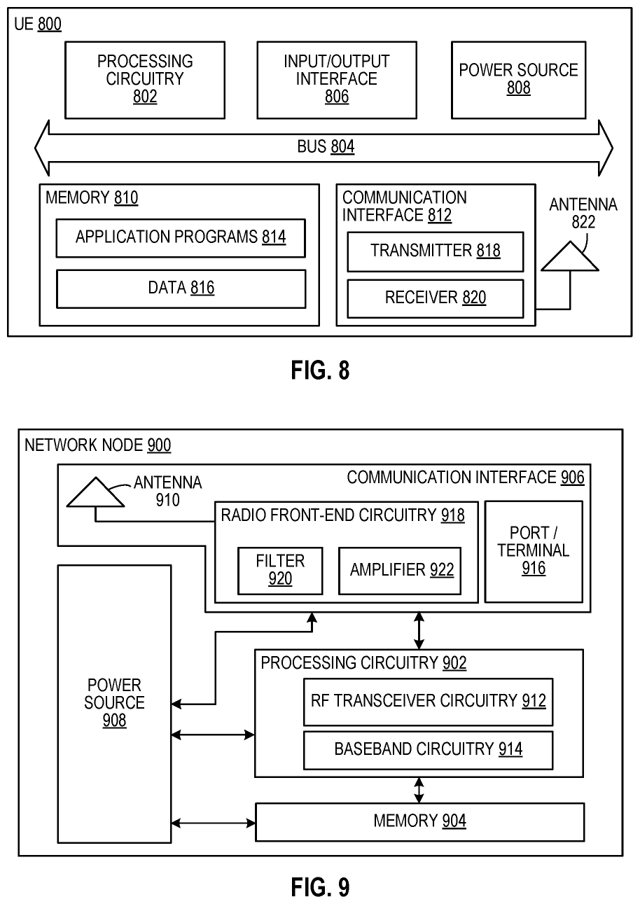

FIG. 8 shows a UE 800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VolP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In the illustrated embodiment, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (Iot) device, may be a device for use in one or more application domains, these domains comprising, but not limited to, city wearable technology, extended industrial application and healthcare. Non-limiting examples of such an Iot device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 8.

As yet another specific example, in an Iot scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node 900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes a processing circuitry 902, a memory 904, a communication interface 906, and a power source 908. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, to provide network node 900 functionality.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and memory 904 is integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, the antenna 910, the communication interface 906, and/or the processing circuitry 902 may be configured to perform any transmitting operations described herein as being performed by the network node. Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

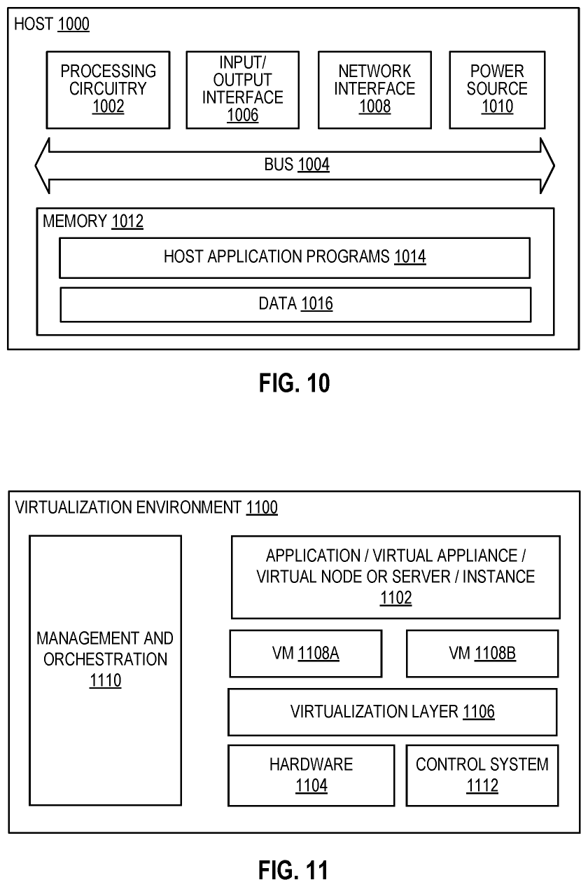

FIG. 10 is a block diagram of a host 1000, which may be an embodiment of the host 716 of FIG. 7, in accordance with various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such as FIGS. 8 and 9, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g. such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1.-24. (canceled)

25. A method performed by network equipment in a communication network, the method comprising:
jointly adapting time division duplexing (TDD) patterns of respective cells in the communication network, based on performance of the TDD patterns in combination; and
based on the adapted TDD patterns, jointly scheduling communication devices served by the cells wherein the TDD patterns are jointly adapted less often than the communication devices are jointly scheduled.

26. The method of claim 25, wherein the TDD patterns are jointly adapted in an outer closed loop and the communication devices are jointly scheduled in an inner closed loop, wherein a metric characterizing the performance of the TDD patterns in combination is an input to the outer closed loop, and wherein the adapted TDD patterns are an output of the outer closed loop and are an input to the inner closed loop.

27. The method of claim 25, wherein jointly adapting the TDD patterns comprises selecting, from different candidate combinations of TDD patterns, a combination of TDD patterns with which to configure the respective cells, based on respective performances of the candidate combinations of TDD patterns, and wherein jointly scheduling the communication devices comprises selecting, from different candidate combinations of schedules in the cells, as configured with the selected combination of TDD patterns, a combination of schedules with which to schedule communication devices served by the cells, wherein a schedule in a cell indicates resources allocated across communication devices served by the cell and/or parameters for transmission to and/or from communication devices served by the cell.

28. The method of claim 27, wherein said selecting comprises:
computing, for each of the candidate combinations of TDD patterns, a cumulative reward achievable by the candidate combination as a function of a metric characterizing the performance of the TDD patterns in the candidate combination; and
selecting, from among the candidate combinations of TDD patterns, the candidate combination for which the cumulative reward computed is maximum.

29. The method of claim 25, wherein jointly adapting the TDD patterns comprises jointly adapting the TDD patterns based on a metric characterizing the performance of the TDD patterns in combination, wherein the metric characterizes the performance as a function of one or more of:
interference between the cells as configured with the TDD patterns;
sum-throughput of the cells as configured with the TDD patterns; or
traffic latency in the cells as configured with the TDD patterns.

30. The method of claim 25, wherein jointly adapting the TDD patterns comprises jointly adapting the TDD patterns based on a metric characterizing the performance of the TDD patterns in combination, wherein the metric characterizes the performance as a function of interference measured by sensors deployed in respective coverage areas of the cells.

31. The method of claim 30, wherein at least some of the sensors are deployed at fixed locations, are dedicated to measuring interference, and/or are configured to measure interference during times or under conditions that the communication devices are unable to measure interference.

32. The method of claim 25, wherein jointly adapting the TDD patterns comprises jointly adapting the TDD patterns based on a metric characterizing the performance of the TDD patterns in combination, subject to a requirement that adaptation of the TDD patterns must improve performance of the TDD patterns in combination by at least a margin, as characterized by the metric.

33. The method of claim 32, further comprising adapting the margin as a function of one or more of:
quality of service requirements for traffic in the cells;
respective numbers of communication devices in the cells; or
resources available in the cells.

34. The method of claim 25, wherein jointly adapting the TDD patterns comprises jointly adapting the TDD patterns also based on characteristics of traffic in the respective cells.

35. The method of claim 25, wherein jointly scheduling the communication devices comprises jointly:
allocating resources across the communication devices; and/or
adapting parameters for transmission to and/or from the communication devices.

36. The method of claim 35, wherein allocating resources comprises allocating resources in a time domain, a frequency domain, and/or a spatial domain.

37. The method of claim 25, wherein jointly scheduling the communication devices comprises jointly scheduling the communication devices based on information characterizing how close each communication device is to an edge of the cell serving that communication device.

38. The method of claim 37, wherein jointly scheduling the communication devices based on information characterizing how close each communication device is to an edge of the cell serving that communication device comprises:
jointly allocating resources across the communication devices by preferentially allocating, to communication devices that the information characterizes as being located close to the respective edges of the cells serving the communication devices, resources that are separated by at least a defined distance in a frequency domain and/or a spatial domain; and/or
jointly adapting parameters for transmission to and/or from the communication devices by preferentially configuring communication devices that the information characterizes as being located close to the respective edges of the cells serving the communication devices with higher transmit power, lower modulation order, and/or lower channel coding rate than communication devices that the information characterizes as being not located close to the respective edges of the cells serving the communication devices.

39. The method of claim 25, wherein jointly scheduling the communication devices comprises jointly scheduling the communication devices based also on mobility characteristics of the respective communication devices, wherein the mobility characteristics of a communication device characterize whether the communication device is mobile or stationary.

40. The method of claim 25, wherein at least some of the cells are provided by different access network nodes in the communication network.

41. The method of claim 25, wherein the communication network is an industrial internet-of-things network, and wherein at least some of the cells provide communication coverage for different factory halls.

42. Network equipment configured for use in a communication network, the network equipment comprising:
communication circuitry; and
processing circuitry configured to:
jointly adapt time division duplexing (TDD) patterns of respective cells in the communication network, based on performance of the TDD patterns in combination; and
based on the adapted TDD patterns, jointly schedule communication devices served by the cells.

43. The network equipment of claim 42, wherein the TDD patterns are jointly adapted in an outer closed loop and the communication devices are jointly scheduled in an inner closed loop, wherein a metric characterizing the performance of the TDD patterns in combination is an input to the outer closed loop, and wherein the adapted TDD patterns are an output of the outer closed loop and are an input to the inner closed loop.

44. The network equipment of claim 42, wherein the processing circuitry is configured to:
jointly adapt the TDD patterns by selecting, from different candidate combinations of TDD patterns, a combination of TDD patterns with which to configure the respective cells, based on respective performances of the candidate combinations of TDD patterns, and
jointly schedule the communication devices by selecting, from different candidate combinations of schedules in the cells, as configured with the selected combination of TDD patterns, a combination of schedules with which to schedule communication devices served by the cells, wherein a schedule in a cell indicates resources allocated across communication devices served by the cell and/or parameters for transmission to and/or from communication devices served by the cell.
